(19) United States
(12) Patent Application Publication
(10) Pub. No.: US 2009/0049135 A1
(43) Pub. Date: Feb. 19, 2009

(54) SYSTEM AND METHOD FOR MANAGING AN INSTANT MESSAGING COMMUNITY

(76) Inventors: Patrick J. O'Sullivan, Dublin (IE); Edith H. Stern, Yorktown Heights, NY (US); Robert C. Weir, Westford, MA (US); Barry E. Willner, Briarcliff Manor, NY (US)

Correspondence Address: HOFFMAN WARNICK LLC, 75 STATE STREET, 14TH FLOOR, ALBANY, NY, 12207, US

(21) Appl. No.: 11/839,691

(22) Filed: Aug. 16, 2007

(51) Int. Cl. G06F 15/16

(52) U.S. Cl. 709/206

(57) ABSTRACT

A system and method exploits organizational distances associated with an organizational hierarchy in a directed acyclic graph to both affect behavior in instant messaging systems, as well as to modify behavior (presence, IM, availability, who can get to the IM user) based on the reporting relationships that exist in an organization. One part of the invention is in exploiting a directed acyclic graph for the purposes of controlling instant messaging behavior for an individual, a team or a community. This is accommodated by abstracting organizational reporting relationships. The reporting relationships that exist in LDAP are used to enforce top-down rules which determine actions that motivate a change in behavior for instant messaging users across the organization. Such actions are not possible to motivate in conventional art. Conventional art relies on rules that a specific user manually builds, and do not consider capabilities around hierarchical imposition, not a reporting team/group/organizational. The present invention may force a change in behavior for a plurality of instant messaging users based on reporting relationships.

### FIELD OF THE INVENTION

The present invention relates generally to instant messaging systems and, more specifically, to a system and method for managing an instant messaging community.

### BACKGROUND OF THE INVENTION

Today, instant messaging is used as a general tool for broader real time collaboration. Instant messaging (IM) is a form of real-time communication between two or more people based on typed text. The text is conveyed via computers connected over a network such as the Internet.

Instant messaging systems evolved from the need for real-time communications that address legacy snail communication systems that implemented a 1 to 1 messaging paradigm. This has led to an explosion of real-time instant messaging collaborations in which many people collaborate in real-time within and across communities. However, the present mechanisms that are used to manage the explosion of instant messaging interactions and presence information awareness do not provide important capabilities to manage this collaboration. (Presence information is a status indicator that conveys ability and willingness of a potential communication partner—for example, a requesting partner to communicate with. A user's client provides presence information (presence state) via a network connection to a presence service, which is stored in what constitutes his personal availability record (called a presentity) and can be made available for distribution to other users (called watchers) to convey his availability for communication. Presence information has wide application in many communication services and is one of the innovations driving the popularity of instant messaging. More information can be found here: http://www.mastemewmedia.org/news/2004/09/23/presence_awareness_indicators_where.htm.) What is needed is a way to make instant messaging more useful and focused for more effective collaboration.

Conventional art permits a bottom up (user defined) implementation of users' preference with respect to the potential community that they can reside in, and how they can limit interactions from that community and visibility within it, e.g., who can see an IM user, who can interrupt an IM user (via intelligent volume controls established by the interrupting IM user), communicating when the IM user is away, when the IM user is offline, and so on. Conventional art does not impose limits on how one individual can modify or manage the behavior of another and hence is substantially limited in corporate environments. Specifically, conventional art permits individuals to modify their own view of the world (who can see the IM user, who can interrupt the IM user, when the IM user is online, when the IM user is away), but it does not allow superiors or managers to control this world.

For example, it may be desirable for one individual (a manager) with authority to be able to control who can “see” or be aware of (presence-wise) a member of their staff so as to control the level of interruptions based on the manager's requirements. This may or may not require or involve agreement by the employee. In another example, it may be desirable for a member of a personnel department to temporarily or permanently limit capabilities (imposed) such that two or more individuals are never aware of one another's presence status, or cannot see one another, or cannot IM one another. Likewise, it may be desirable for one individual (a manager) to have authority to restrict a buddy list on an individual (a “buddy list” is a list of frequent contacts used in connection with Internet software and IM clients) or their team so as to enforce constraints in usage and limit visibility inbound and outbound. Likewise, it may be desirable for one individual who has authority to limit the inbound and outbound view of the world that an individual or plurality of individuals may have for reasons associated with productivity, disputes, competition and so forth.

These examples are particularly pertinent when one considers multi-tenancy on a single IT infrastructure. In such situations, multiple companies or business entities may co-reside on a single infrastructure, as for example in an SO hosting center, or as in an entity constructed of multiple sub-entities. An “SO hosting center” is a Service Offering Hosting center. A company, which decides to outsource its IT infrastructure, may contract with an SO hosting center. The ability to isolate their IM views based on hierarchy can provide the ability to substantially provide independent IM functions, without the necessity of independent infrastructure.

There is presently a need for a system and method that exploits organizational distances associated with an organizational hierarchy in a directed acyclic graph to both affect behavior in instant messaging systems, as well as to modify behavior (presence, IM, availability, who can get to the IM user) based on the reporting relationships that exist in an organization. Such a system and method would be compelling in a company's instant messaging community, but would be far more compelling when IM gateways (e.g., IBM® Lotus® Sametime® Gateway) allow an individual or an entire team to interact with (and be disturbed by) many other small/large external communities. Controlling the degree of interaction is key to ensuring productivity and keeping teams and communities focused where needed.

The IBM® SIP Presence Server and the Microsoft® Presence Server are enterprise applications which collect, manage, and distribute real-time presence information to applications and users in real time. In IBM's implementation, the presence server allows the publishing and notification of presence information (through subscribe events) so that users receive notifications of changes for users that they have on their buddy list.

Conventional art also maintains a set of rules and associations, governing who can see who (e.g., DND, selective DND), DND, or Do not disturb, is an internet slang mostly used in instant messaging systems and means that one IM user shouldn't disturb or talk to the IM user that has DND attached to his name. The IBM SIP Presence Server is developed using industry-standard protocols such as those defined by IETF and Session Initiation Protocol (SIP). Other presence servers (such as those from Microsoft and AOL) are implemented in similar ways. In order to provide a scalable presence server it needs be deployed it in a distributed environment and on more than one server machine (through vertical or horizontal scaling).

There is currently a need for a system and method that exploit organizational distances associated with an organizational hierarchy in a directed acyclic graph to both affect behavior in instant messaging systems, as well as to modify behavior (presence, IM, availability, who can get to the IM user) based on the reporting relationships that exist in an organization.

### BRIEF SUMMARY OF THE INVENTION

The present invention is system and method that exploit organizational distances associated with an organizational hierarchy in a directed acyclic graph to both affect behavior in instant messaging systems, as well as to modify behavior (presence, IM, availability, who can get to the IM user) based on the reporting relationships that exist in an organization.

The core of the invention is in exploiting a directed acyclic graph (e.g. LDAP directory) (a graph is acyclic if it contains no cycles) for the purposes of controlling instant messaging behavior for an individual, a team or a community. This is accommodated by abstracting organizational reporting relationships (e.g., that are implicit in directed acyclic graphs such as can be constructed from LDAP directories). In the preferred embodiment, the reporting relationships that exist in LDAP are used to enforce top-down rules which determine actions that motivate a change in behavior for instant messaging users across the organization. Such actions are not possible to motivate in conventional art. Conventional art relies on rules that a specific user manually builds, and do not consider capabilities around hierarchical imposition, not a reporting team/group/organizational.

Further, the system and method of the present invention may force a change in behavior for a plurality of instant messaging users based on reporting relationships (e.g., an IM user can only see team A, an IM user cannot talk to John, Frank cannot see an IM user, Group B does no know an IM user exist even though an IM user is online, an IM user cannot see anyone outside his assigned buddy list, an IM user cannot mature his buddy list by adding other users, an IM user buddy list is imposed by his manager and cannot be extended without permissions, an IM user can talk to Joe or Joe's team after 6 PM or before 9 AM, and so on).

Likewise, controlling user behavior in this application is not restricted to a single community.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts the system of the present invention.

FIG. 2 represents the method of the present invention.

FIG. 3 illustrates more detail of the method of the present invention.

FIG. 4 illustrates more detail of the method of the present invention

FIG. 5 illustrates an example of a policy table for a user.

The drawings are intended to depict only typical aspects of the invention, and therefore should not be considered as limiting the scope of the invention. In the drawings, like numbering represent like elements between the drawings.

### DETAILED DESCRIPTION OF THE PREFERRED EMBODIMENT OF THE PRESENT INVENTION

The present invention provides system and method that exploit organizational distances associated with an organizational hierarchy in a directed acyclic graph to both affect behavior in instant messaging systems, as well as to modify behavior (presence, IM, availability, who can get to the IM user) based on the reporting relationships that exist in an organization.

As a matter of background, SIP Presence and Instant Messaging Servers are applications that collect, manage, and distributes real-time presence and instant messaging information to applications and users on a needs basis. The IBM presence server and Instant messaging server are developed using industry-standard protocols such as those defined by IETF (Internet Engineering Task Force); Session Initiation Protocol (SIP) and the extension and SIMPLE (SIP Instant Messaging and Presence Leveraging Extensions) working groups.

As per the RFCs, presence servers support Register, Publish, Subscribe and Notify SIP messages. Register and Publish messages are requests generated by the SIP client, which add/modify/remove a segment of the presence information of a certain presence-entity for a defined period of time (expiration time). These requests can also be used to only extend the expiration time of the published presence information. The presence information is managed by the presence server as long as it doesn't expire. The Register and Publish messages serve the same purpose, however they have different headers which imply different handling of the presence information. Publish messages include a mechanism to identify adding/modifying/removing a segment of the presence information or updating the expiration time for a segment (the “sip-if-match” header). As a result each Publish request relates to a specific segment. On the other hand, Register requests do not include such a mechanism, and so there is no way of associating a Register request with a specific segment of the presence information. Another difference is that a Publish request contains a single “Expires” header, which allows managing one expiration time for each segment. On the other hand, a single REGISTER request may include several expiration times for different parts of the updated presence information

Subscribe message is generated by the SIP client, and is a request for the current presence information state for a certain presence-entity, and for updates on that state, for a defined period of time. re-Subscribe messages can be used to extend the expiration time of the original Subscribe request. Notify messages are requests generated by the server to notify subscribers of updates in the presence information of that certain presence-entity. When the Subscribe request arrives, the presence information of the presence-entity is retrieved and sent to the subscriber using a Notify message. As long as the subscription is valid (did not expire), any change to the presence information results in sending a new Notify messages to the subscriber.

All Subscribe and re-Subscribe requests, including the Notify responses, form a SIP session, are also referred to as a dialog. The SIP/SIMPLE protocol provides mechanism to ensure that all messages belonging to a single dialog will be handled by the same presence server. As a result, the presence server can assume that Subscribe and re-Subscribe messages for the same subscription session will be handled by the same presence server. Each SIP request is followed by a response, indicating the outcome of processing the SIP request (e.g., OK response).

Significantly, for one user to be aware (see) another user, a contract must be established between these users. Specifically user A, who wishes to instant message user B, must have subscribed to that user's (user B) presence state. At that point user A can instant message user B. The reverse is also true.

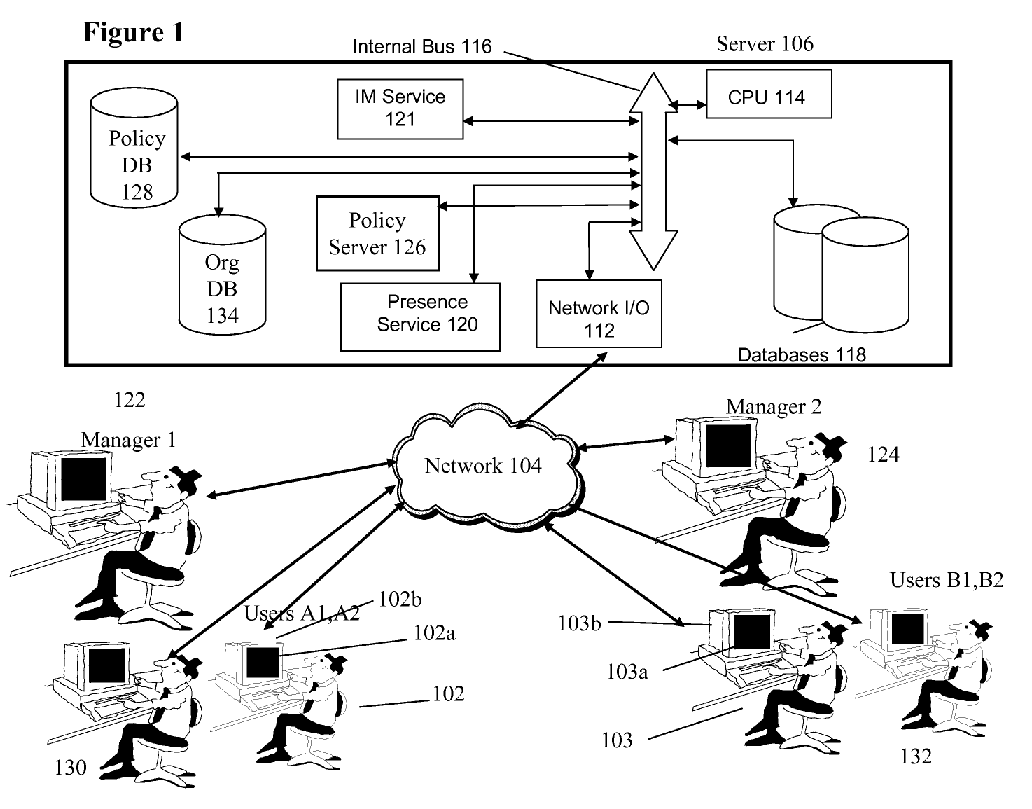

FIG. 1 illustrates the IM system 100 of the present invention. IM User A1 (102) wishes to communicate with IM User B1 (103). Instead of phoning, IM User A1 (102) uses instant messaging. Instant messaging allows IM User A1's and IM User B1's screens 102a, 103a to illustrate the IM “conversation” between IM User A1 102 and IM User B1 103. Instant messaging requires an instant messaging client 102b, such as IBM's Lotus Sametime® (see http://www-142.ibm.com/software/sw-lotus/sametime), generally installed on a general purpose computer (see http://computer.howstuffworks.com/pc.htm) which has a communications device that connects to IM server 106 via network 104. (However, the IM Devices 102c, 103c don't need to be personal computers as it can as easily be a cell phone, PDA and the like.) Like many servers, IM Server 106 has a network input/output device 112 to receive and send messages, one or more CPUs 114, databases 118 to store data, such as IM messages, and other data related to the IM session, and an internal bus 114 like other computers. IM User A1, who is communicating via IM with IM User B1, sends IM data to User B1 which is stored in databases 118 and is forwarded to IM User B1 103, by IM Service 121, to be displayed on IM Device 103b on IM User B1's Screen 103a. Also, according to typical security procedures, IM User A1 has a key, IM User B1 has a key, and IM Server 106 has a key for authentication purposes.

Server 106 further has a Presence Service 120 which provides presence information (as noted previously, presence information is a status indicator which conveys ability and willingness of a potential communication partner) to IM users. The server 106 of the present invention further has Policy Server 126 and a Policy Database 128. The Server 106 further comprises an Organization Database Server 134 which stores the organizational distances associated with an organizational hierarchy for each user so that the system and method of the present invention is able to modify behavior (presence, IM, availability, who can get to the IM user) based on the reporting relationships that exist in an organization. As an example, the Policy Database 128 receives, from a policy creator (such as, but not limited to, Manager1 (122), Manager2 (124)), policy rules associated with IM users (such as Users A1 (102), A2 (103), B1 (130), B2 (132)). Policy Server 126, upon receiving an IM request (or another trigger) from a requesting IM user, retrieves the policy rules from the Policy Database 128 and the organizational data from the Organization Database Server 134 for the IM requesting user to evaluate whether the IM request needs to be approved or rejected based upon the policy rules received from the Policy Database 128 and, in some cases, the organizational data received from the Organization Database Server 134. For instance, Manager1 (122) may choose that his department (User A1 (102) and User A2 (130)) is not allowed to have IM access outside of his department (which would include User A1 (102) and User A2 (130) in the present example but, of course could include others based upon organizational hierarchy or other factors). Manager1 (122) could also choose that his department cannot has presence information about others outside of his department between certain hours, as an example. Manager1 (122) conveys his rules to Server 106 through Network 104 which are passed to and stored in the Policy Database 128. This information (Policy Rules) is utilized by the Policy Server 126. This will be discussed in greater detail further hereinbelow.

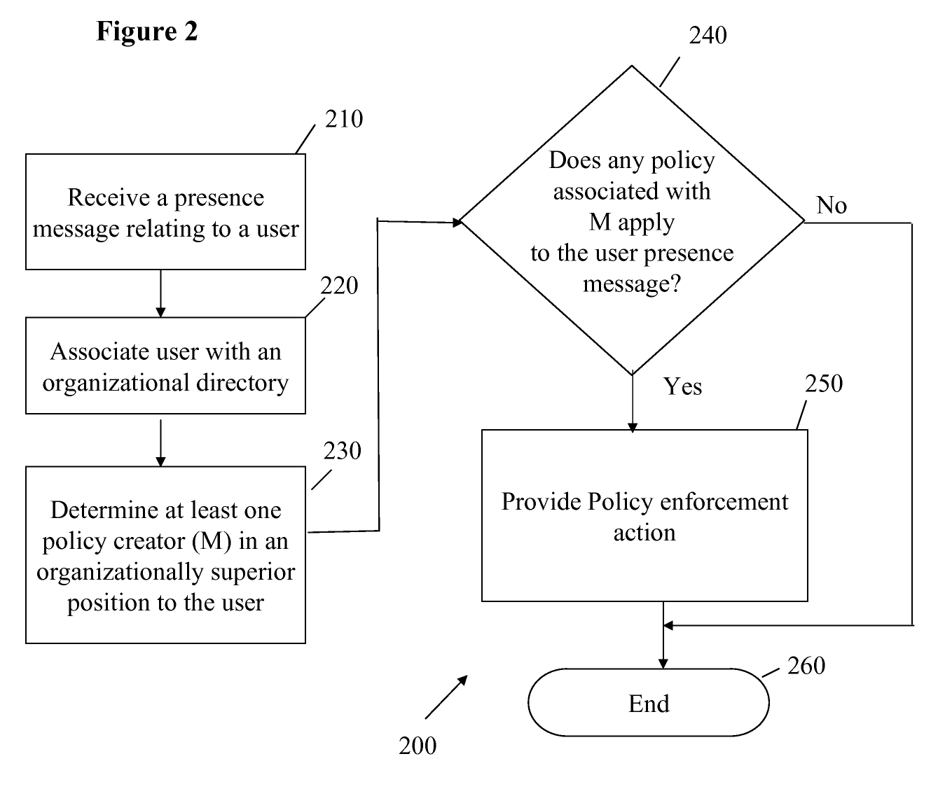

FIG. 2 illustrates one embodiment of the method 200 of the present invention. At step 210, Server 106 receives a presence message from a requesting user, relating to the presence of users. Before the presence information of other users (such as User B1 (102), User A2 (130), User B2 (132)) is passed to the requesting user (such as User A1 (102)), the policy rules stored in the Policy Database 128 and the organization relationships stored in Organization Database 134 must be retrieved and analyzed by the Policy Server 126. The Policy Server 126 analyzes the data received at step 220 to associate the requesting user with the organizational directory received from the Organization Database 134. At step 230, the Policy Server 126 determines at least one policy creator (“M”, such as Manager1 (122), Manager2 (124)) in an organizationally superior position to the requesting user. At step 240, the Policy Server 126 determines whether any policy associated with the policy creator (M) applies to the user presence message by examining the policy rules retrieved previously from the Policy Database 128 and the organization relationships rules retrieved previously from the Organization Database 134 as discussed above. If not, the process ends at 260. If so, at step 250, the Policy Server 126 provides to, in this present example, the Presence Service 120, the policy enforcement action so that the Presence Service 120 can take the appropriate action regarding the received request and the process ends at 260.

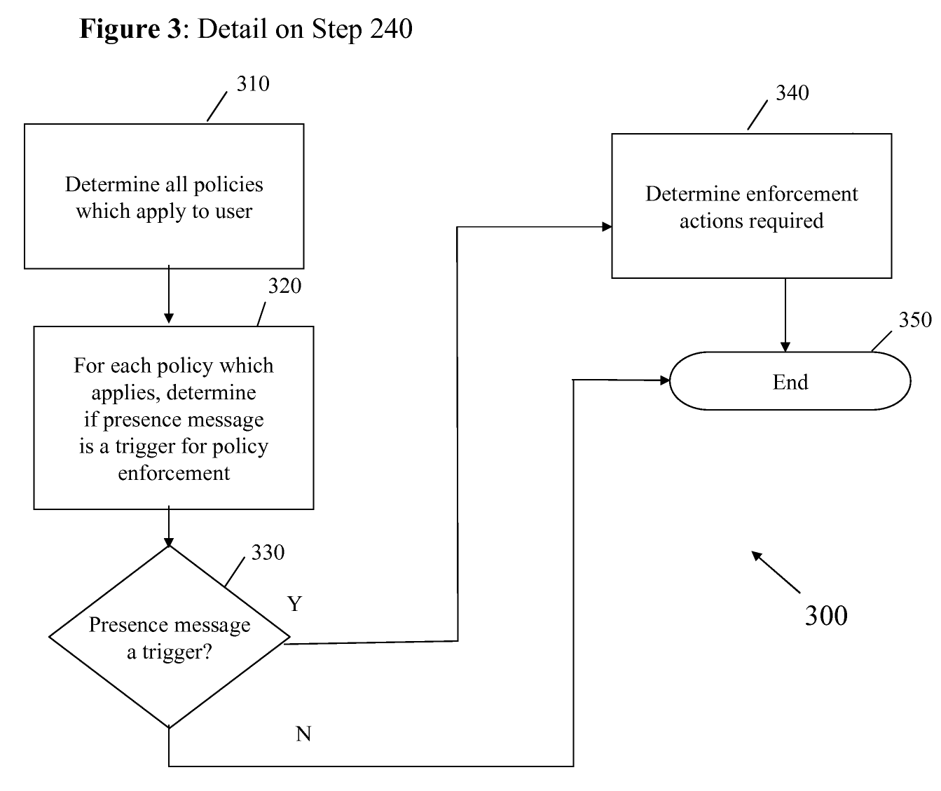

FIG. 3 illustrates more detail on Step 240 of the present invention. At Step 310, the Policy Server 126 by examining the policy rules stored in the Policy Database 128 and the organization relationships stored in Organization Database 134. At step 320, the Policy Server 126 determines, for each policy which applies, whether presence message is a trigger for policy enforcement. At step 330, the Policy Server 126 determines whether the presence message is a trigger and, if not, the process ends at 350. If so, at step 340, the Policy Server 126 determines the enforcement actions required which are included the policy rules previously retrieved from the Policy Database 128 and the process ends at Step 350.

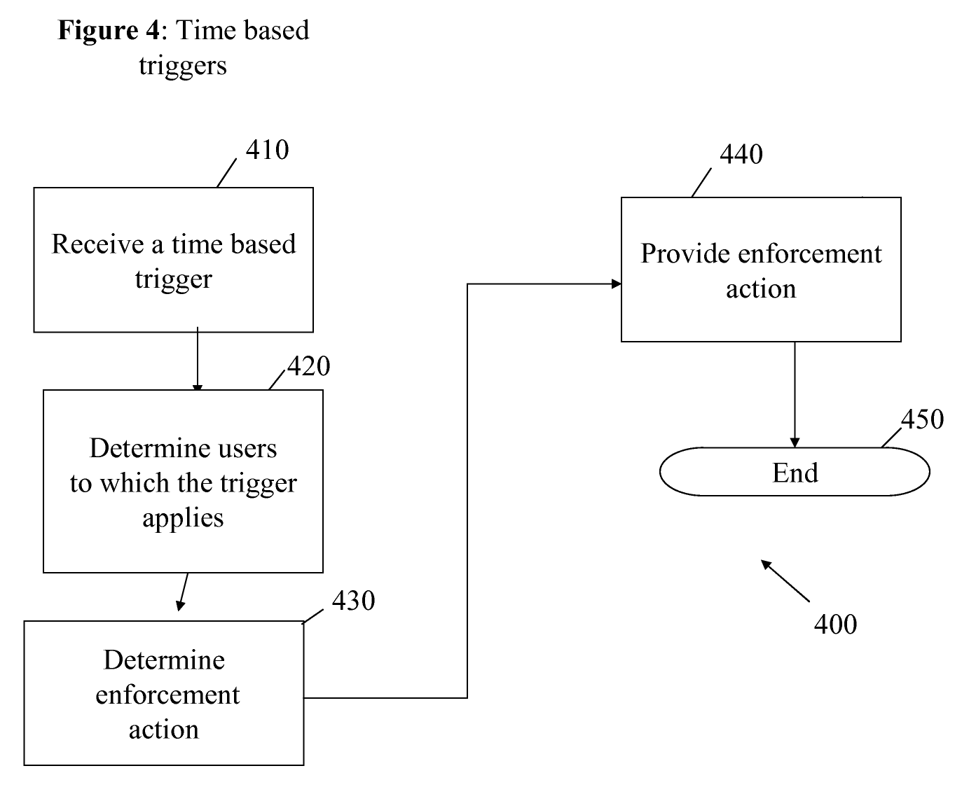

FIG. 4 illustrates the method 400 of the present invention where the Policy Server 126 takes actions based upon time based triggers. At step 410, the Policy Server 126 receives a time based trigger. At step 420, the Policy Server 126 determines to which users the time based trigger applies. At step 430, the Policy Server 126 determines the enforcement action and proceeds to step 440 where the Policy Server 126 provides to the appropriate service (the IM Service 121 or the Presence Service 120 for their processing) the enforcement action required and the process ends at 450.

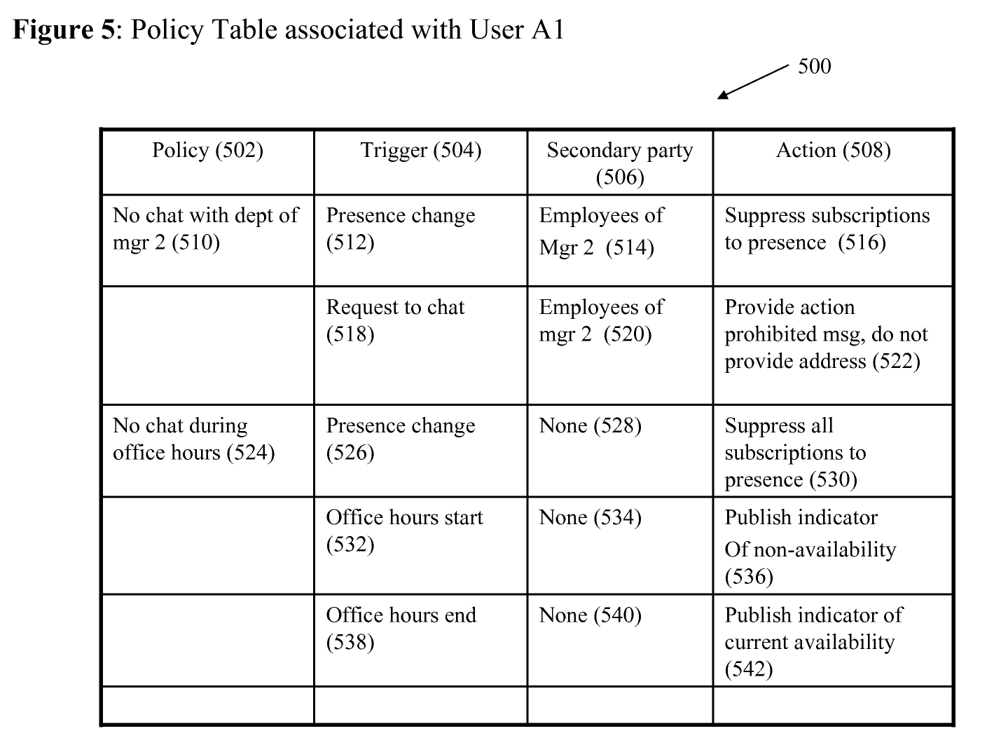

FIG. 5 illustrates an example of a Policy Table 500 for User A1 having a number of characteristics for User A1, such as Policy (502) which identifies the IM/Presence policy associated with the requesting user, Trigger (504) which identifies actions which trigger the system to examine the policy rules, Secondary Party (506), and Action (508). The enforcement actions (508) are the actions required by the Policy Server indicating which actions are allowed and which are not allowed. This information is passed from the policy server to the Presence Service and the IM Service.

For instance, No chat with dept of mgr 2 (510) is the first policy of User A1 which has a first trigger of Presence change (512) and a secondary party of Employees of Mgr 2 (514). With this policy, User A1 is not allowed to chat with any employees within the department of manager 2 and, if there is a presence change of User A1, such as offline to online, the policy is triggered in which case the enforcement action is Suppress subscriptions to presence (516) so that the presence of the employees within the department of manager 2 is suppressed to User A1. Alternatively, within this same policy, if User A1 requests a chat (Request to chat (518)) with any employees within the department of manager 2 (Employees of Mgr 2 (514)), an action prohibited indication is provided to User A1 and the address is not provided (Provide action prohibited msg, do not provide address (522)).

Under another policy (No chat during office hours (524)), User A1 is not allowed to chat during office hours. If trigger (Presence change (526)) is detected, no presence information is allowed via the enforcement action (Suppress all subscriptions to presence (530)). If trigger (Office hours start (532)) is detected, an indicator of non-availability is published to User A1 (Publish indicator of non-availability (536)). If trigger (Office hours end (538)) is detected, an indicator of availability is published to User A1 (Publish indicator of current availability (542)).

The system and method of the present invention provides the following novel aspects:
1. The identification of a manager in a community and the association of this manager with a sub-community for the purposes of controlling this community on an individual, team wide or sub-team basis; and
2. The ability for such a manager to modify behavior of instant messaging users on their team by:
   being able to ring fence their buddy lists—i.e. limit visibility to who can be added to buddy lists;
   being able to manage “away”, “DND”, “offline” and “online” states for their team members—e.g., A manager may choose that John is always seen as “offline” by Joe;
   being able to impose time constraints on instant messaging usage (e.g., John can ping any one he wants before 9 AM and after 6 PM, there within he can only ping his team);
   being able to control outbound behavior in a differential way—e.g., John can ping anyone he wants before 9 AM and after 6 PM, but he can ping his team any time he likes as well as Frank in team 2;
   being able to control inbound behavior in a differential way—e.g., John can ping anyone he wants in Anne's team before 9 AM and after 6 PM, but not within these hours as Anne has set a blanket “can not disturb” policy for her team at this time, however she has not constrained Joe;
   being able to set IM quotas, based on number of communications or aggregate time spent in chatting;
   being able to limit the view of the world an individual or a team may have to other teams or communities—e.g., internal or external (e.g., across gateways);
   being able to limit the degree of interaction in a bounded way—e.g., John can IM Mary only twice today, he can do so before 11 AM, and again after 3 PM;
   being able to identify specific individuals/teams and temporarily or permanently modify the relationship between these individuals—e.g.; John and Joe are simply never allowed to enjoy real time instant messaging chats ever again;
   being able to force propagate a buddy list—individuals that report in to a manager digest a buddy list that their manager imposes. This imposition can represent a superset buddy list (only the manager can add more), or a subset (they user can append); and
   the ability for a manager to limit use cases associated with an individual's ability to add, remove users and groups within communities (internal or external).

The system and method of the preferred embodiment of the invention exploits organizational distances derived in an LDAP tree to: a) establish a list of those in authority that are b) assigned to a team (identified set of instant messaging users) based on organizational units implicit in LDAP branches by c) using reporting information from the LDAP (and indeed location information from the IM client) to assist in the enforcing of rules and constraints relative to decisions imposed by a superior. Subsequently, associated with each IM user is his organizational tree, including manager, direct reports, team (in an individual user's case this would mean their manager's subtree) and so on.

Likewise, in the preferred embodiment, there is a database (Instant Messaging Rules DB) that stores the manager's decisions, preferences and instant messaging behavior criteria for their team. A user interface exists to manage this DB, and this implements the configuration and behavior parameters described above. In this database a manager can decide who can talk to who, when they can talk to each other, how often, and so on. Such a UT is relatively straightforward to create, as it simply record the decisions and preferences that the manager wishes to implement and administer. In the preferred embodiment, this Database forms the basis for an Instant Messaging policy server that serves to enforce these rules. In a preferred embodiment, the UT allows what-ifs, that is, allows the manager to see what the impact of adding an additional rule or constraint will be, as well as to ensure that the new rule or constraint does not cause unexpected results in light of existing rules.

In one preferred embodiment, the instant messaging is implemented on a SIP infrastructure. Here all Register, Publish, Subscribe and Notify SIP messages are intercepted by the presence server and are validated by the Instant Messaging Policy Server which directly references the Instant Messaging Rules DB. If John wants to subscribe to Jane then he is permitted to express this intention through the UT that conventional art provides, but at the point of subscription the presence server will interrogate the instant messaging policy server to confirm that there are no policies set by John's manager related to the individual he wishes to subscribe to. This can be temporary, permanent, or within a certain time window imposed by John's manager. The Instant Messaging Presence Server and Instant Messaging server respect this policy decision. On the other side the same validation is performed for the opposite user, assuming that a policy server and instant messaging rules DB exists.

It should be noted that, in addition to enterprise use, there are many other use cases. For example, consider students in a school or university setting. It may be desirable to apply hierarchy in conjunction with other rules to limit IM communications. Under some circumstances, a teacher may choose to disallow IM to students outside the class during the class. Under other circumstances, a teacher may choose to disallow IM to students within the class during the class. Temporarily limiting communications may serve to focus the attention of the class.

Use of this invention is an additional mechanism to ensure compliance, and compliance auditing. That is, it may reduce the communications that may be subject to such auditing.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. An instant messaging (IM) system for managing an instant messaging community and for passing instant messages between at least two IM users and for showing presence of the at least two IM users to the at least two IM users, comprising:
a service for providing to a first user, presence information related to a second user;
a store of organizational information, which includes at least one reporting relationship associated with a first user; and at least one reporting relationship associated with a second user;
a process for providing a policy rule associated with the first user; and
a process for evaluating the policy rule provided, responsive to the reporting relationships of the first user and the second user, and providing an indication of IM service responsive to the evaluation.

2. The system of claim 1 further comprising a process for providing a policy rule associated with the second user.

3. The system of claim 1 wherein the indication is a denial of service and providing that indication to the requesting user.

4. The system of claim 1 wherein the policy rule includes at least one of the following factors: time of day, mode of connectivity, location of service, outbound behavior in a differential way, inbound behavior in a differential way, IM quotas, constraints on interaction in a bounded way, or identification of specific individuals or teams and temporarily or permanently modify the relationship between these individuals or teams and the evaluation is based upon the factor.

5. The system of claim 1 wherein there is at least one policy rule associated with the first user which is created by a third user, the third user being in a reporting hierarchy with the first user.

6. A method, in instant messaging (IM) system for managing an instant messaging community and for passing instant messages between at least two IM users and for showing presence of the at least two IM users to the at least two IM users, the system comprising a presence service for receiving, from a requesting IM user, a request for presence information of at least one other IM user, and for providing presence service between the at least two IM users and an IM service for providing IM service between requesting IM user and the second IM user and for receiving a request from a requesting IM user to send an instant message to second IM user, the method comprising the steps of:
receiving a messaging request from a first user associated with a second user;
determining at least one policy rule related to the user;
determining an organizational relationship between the first and second users;
evaluating the request responsive to the at least one policy rule and the organizational relationship; and
providing an indication of the evaluation.

7. The method of claim 6 wherein the indication is a denial of service such that the requesting user is denied access to presence information or IM access, depending upon the request of the requesting user and providing that indication to the requesting user.

8. The method of claim 6 wherein the indication is an approval of service such that the requesting user is approved of access to presence information or IM access, depending upon the request of the requesting user.

9. The method of claim 6 wherein the policy rule includes at least one of the following: the factors of time of day, mode of connectivity and location of service, outbound behavior in a differential way, inbound behavior in a differential way, IM quotas, constraints on interaction in a bounded way, or identification of specific individuals or teams and temporarily or permanently modify the relationship between these individuals or teams and the evaluation is based upon at least one of those factors.

10. The method of claim 6 wherein the policy rules are conveyed to the policy database by a policy creator, such as a manager.

11. The method of claim 6 wherein the at least two IM users have a buddy list and the indication is to distinguish a buddy contact on the list, such as by color or font.

12. The method of claim 6 wherein the policy rules include being able to limiting visibility as to who can be added to a buddy list.

13. A computer program product in a computer readable medium for operating in a system comprising a network I/O, a CPU, and one or more databases, for implementing a method for managing an instant messaging community and for passing instant messages between at least two IM users and for showing presence of the at least two IM users to the at least two IM users, the system comprising a presence service for receiving, from a requesting IM user, a request for presence information of at least one other IM user, and for providing presence service between the at least two IM users and an IM service for providing IM service between requesting IM user and the second IM user and for receiving a request from a requesting IM user to send an instant message to second IM user, the method comprising the steps of:
receiving a request for IM information from a requesting user, wherein the IM information is presence information or IM address information;
retrieving policy rules associated with the requesting IM user;
retrieving the reporting relationship of the requesting IM user; and
evaluating the retrieved policy rules and the reporting relationship of the requesting IM user; and
providing an indication of allowable service to the IM service and the presence service based upon the evaluation.

14. The computer program product of claim 13 wherein the indication is a denial of service such that the requesting user is denied access to presence information or IM access, depending upon the request of the requesting user and providing that indication to the requesting user.

15. The computer program product of claim 13 wherein the indication is an approval of service such that the requesting user is approved of access to presence information or IM access, depending upon the request of the requesting user.

16. The computer program product of claim 13 wherein the policy rule includes at least one of the following factors: time of day, mode of connectivity, outbound behavior in a differential way, inbound behavior in a differential way, IM quotas, constraints on interaction in a bounded way, or identification of specific individuals or teams and temporarily or permanently modify the relationship between these individuals or teams and location of service and the evaluation is based upon at least one of those factors.

17. The computer program product of claim 13 wherein the policy rules are conveyed to the policy database by a policy creator, such as a manager.

18. The computer program product of claim 13 wherein the at least two IM users have a buddy list and the indication is distinguish a buddy contact on the list, such as by color or font.

19. The computer program product of claim 13 wherein the policy rules include being able to ring fence a user's buddy lists such that the visibility to who can be added to buddy lists is limited.

20. An instant messaging (IM) system for managing an instant messaging community and for passing instant messages between at least two IM users and for showing presence of the at least two IM users to the at least two IM users, comprising:
a presence service for receiving, from a requesting IM user, a request for presence information of at least one other IM user, and for providing presence service between the at least two IM users and;
an IM service for providing IM service between requesting IM user and the second IM user and for receiving a request from a requesting IM user to send an instant message to a second IM user;
a policy store for receiving and storing policy rules associated with the requesting IM user;
an organizational store for storing the reporting relationship that exist in the organization of the requesting IM user; and
a policy server for retrieving policy rules associated with the requesting IM user, for retrieving the reporting relationship that exist in the organization of the requesting IM user, for evaluating the retrieved policy rules and the reporting relationship of the requesting IM user and for providing an indication of service to the IM service and the presence service based upon the evaluation; and
wherein the policy rule comprises at least one of the following: time constraints on instant messaging or presence usage, outbound behavior in a differential way, inbound behavior in a differential way, IM quotas, constraints on interaction in a bounded way, or identification of specific individuals or teams and temporarily or permanently modify the relationship between these individuals or teams.

21. The system of claim 20 wherein the policy server further provides for forcing the propagation of a buddy list.
